(19) United States
(12) Patent Application Publication
(10) Pub. No.: US 2013/0108281 A1
(43) Pub. Date: May 2, 2013

(54) TONER CARTRIDGE AND PRINTER USING THE SAME AND RELATED PROTECTION MANAGEMENT METHOD

(71) Applicant: Yu-Cheng Chang, New Taipei City (TW)

(72) Inventor: Yu-Cheng Chang, New Taipei City (TW)

(73) Assignee: KINPO ELECTRONICS, INC., New Taipei City (TW)

(21) Appl. No.: 13/330,692

(22) Filed: Dec. 20, 2011

(30) Foreign Application Priority Data
Oct. 31, 2011 (TW) 100139620

(51) Int. Cl. G03G 15/08

(52) U.S. Cl. 399/12; 399/27

(57) ABSTRACT

A toner cartridge and a printer using the same and a related protection management method are provided. In the present disclosure, by additionally equipping a hardware configuration of identification unit in the toner cartridge, the equipped identification unit would provide a (unique) ID code representing the toner cartridge in response to a setting code (randomly) determined by a controller of the printer. Only when the setting code and the ID code are the same, and when the toners filled inside the toner cartridge are not empty yet, is the printer allowed to normally operate; otherwise, the printer is stopped from using the toner cartridge, and the user is asked to replace a new genuine toner cartridge. Accordingly, it is assured that the internal components of the printer won't be damaged by the unidentified, low-priced dummy toner cartridges, and the print quality and service lifetime of the printer would be maintained.

### CROSS-REFERENCE TO RELATED APPLICATION

This application claims the priority benefit of Taiwan application serial no. 100139620, filed on Oct. 31, 2011. The entirety of the above-mentioned patent application is hereby incorporated by reference herein and made a part of this specification.

### BACKGROUND OF THE INVENTION

1. Technology Field

The present disclosure generally relates to an image output device, and more particularly, to toner cartridge and a printer using the same, and the related protection management method.

2. Description of Related Art

The arrival of the information era not only increases the popularity of personal computers, but also boosts the market for computers and the peripheral products thereof. Therefore, all kinds of information technology related products are pushed to the market, and information technology related devices have become more diversified. However, the means for displaying images of computers are mostly limited to monitors or printers. Among them, printers can be divided into three categories: dot matrix printer, inkjet printer, and laser printer.

No matter which category of printer, a printer of a specific model requires a corresponding toner cartridge for printing. Once the toner in the toner cartridge runs out, the toner cartridge must be replaced. Otherwise, the printer cannot continuously perform any print task. However, due to the relative higher price of the genuine toner cartridges, some users would choose to purchase low-priced dummy toner cartridges to extend the print function of the printer.

Nevertheless, due to the potentially huge difference in quality between the toner in the dummy toner cartridge and the genuine toner cartridge, using dummy toner cartridge may cause damage to the internal components of the printer, or may even dramatically affect the print quality and service lifetime of the printer.

### SUMMARY OF THE INVENTION

Accordingly, the current disclosure provides a toner cartridge and a printer using the same, and a related protection management for mitigating the problems described above.

An embodiment of the present disclosure provides a toner cartridge for a printer. The toner cartridge includes a hardware configuration of identification unit and a toner supplying unit. The hardware configuration of identification unit generates an ID code representing the toner cartridge in response to a setting code determined by a controller of the printer. Under a condition of that the controller determines that the ID code is the same as the setting code, the toner supplying unit supplies a black toner and/or a color toner in response to a print task executed by the controller.

Another embodiment of the present disclosure provides a printer including a controller, the toner cartridge mentioned above, and a memory unit. The controller is coupled to the memory unit, and used to be served as an operation core of the printer. The memory unit is used to store the setting code.

In an embodiment of the present disclosure, when the controller determines that the setting code is not the same as the ID code, the controller would stop using the toner cartridge and issue a first warning message.

In an embodiment of the present disclosure, the printer further includes a counter, which is coupled to the controller. The counter is used for counting a total number of printing sheets of the printer and providing a counting value accordingly.

In an embodiment of the present disclosure, the memory unit is further used to store the counting value provided by the counter. In addition, when the controller determines that the counting value, which is provided by the counter, is larger than a predetermined value, the controller stops using the toner cartridge and issues a second warning message.

In an embodiment of the present disclosure, the printer further includes a display unit, which is coupled to the controller. The display unit is used to display the first warning message and the second warning message.

In an embodiment of the present disclosure, the controller may randomly determine the setting code.

In an embodiment of the present disclosure, the setting code is updated in response to a new toner cartridge equipped with the hardware configuration of identification unit.

In an embodiment of the present disclosure, the hardware configuration of identification unit may be a programmable fuse array or a programmable impedance component array.

In an embodiment of the present disclosure, the toner supplying unit may include a first toner supplying subunit and a second toner supplying subunit. The first toner supplying subunit is used to supply black toner, and the second toner supplying subunit is used to supply color toner.

In an embodiment of the present disclosure, the printer further includes a print module, which is coupled to the controller. The print module is used to output a print document related to the print task executed by the controller.

In an embodiment of the present disclosure, the printer may be a laser printer, an inkjet printer, or a dot matrix printer.

Another embodiment of the present disclosure provides a protection management method for a printer. The protection management method includes additionally equipping a hardware configuration of identification unit in a toner cartridge corresponding to the printer; making the hardware configuration of identification unit to generate an ID code representing the toner cartridge in response to the setting code determined by a controller of the printer; determining whether the setting code and the ID code are the same; and making the toner cartridge to supply a black toner and/or a color toner in response to the print task executed by the controller under a condition of that the setting code is determined to be the same as the ID code.

In an embodiment of the present disclosure, the protection management method further includes making the controller stop using the toner cartridge and issues a first warning message under a condition of that the setting code is determined to be different from the ID code.

In an embodiment of the present disclosure, the protection management method further includes displaying the first warning message.

In an embodiment of the present disclosure, after the setting code is determined to be the same as the ID code, the protection management method further includes counting the total number of printing sheets of the printer and providing a counting value accordingly; determining whether the counting value is larger than a predetermined value; making the controller stop using the toner cartridge and issue a second warning message when the counting value is determined to be larger than the predetermined value.

In an embodiment of the present disclosure, the protection management method further includes displaying the second warning message.

In an embodiment of the present disclosure, the protection management method further includes making the toner cartridge supply the black toner and/or the color toner in response to the print task executed by the controller when the counting value is determined to be not larger than the predetermined value.

Based on the above, by additionally equipping a hardware configuration of identification unit (for example, programmable fuse array or programmable impedance component array) in the toner cartridge, the equipped hardware configuration of identification unit would generate a (unique) ID code representing the toner cartridge in response to the setting code (randomly) determined by the controller of the printer. Only when the setting code and the ID code are the same, and when the (black or color) toner filled in the toner cartridge is not empty yet, is the printer allowed to operate normally. Otherwise, the printer is stopped from using the toner cartridge, and the user would be asked to replace a new genuine toner cartridge. As a result, it is assured that not only the internal component of the printer would be protected from being damaged by unidentified and low-priced dummy toner cartridge, but also the print quality and the service lifetime of the printer can be maintained.

It should be understood, however, that this Summary may not contain all of the aspects and embodiments of the disclosure, that this Summary is not meant to be limiting or restrictive in any manner, and that the disclosure as disclosed herein is and would be understood by those of ordinary skill in the art to encompass obvious improvements and modifications thereto.

### BRIEF DESCRIPTION OF THE DRAWINGS

The accompanying drawings are included to provide a further understanding of the disclosure, and are incorporated in and constitute a part of this specification. The drawings illustrate embodiments of the invention and, together with the description, serve to explain the principles of the disclosure.

FIG. 1 is a diagram of the printer 10 according to an embodiment of the present disclosure.

FIG. 2 is a flow chart illustrating the printer protection management method according to an embodiment of the present disclosure.

### DESCRIPTION OF THE EMBODIMENTS

References would now be made in detail to the exemplary embodiments of the disclosure, examples of which are illustrated in the accompanying drawings. Wherever possible, the same reference numbers are used in the drawings and the description of the embodiments to refer to the same or like parts.

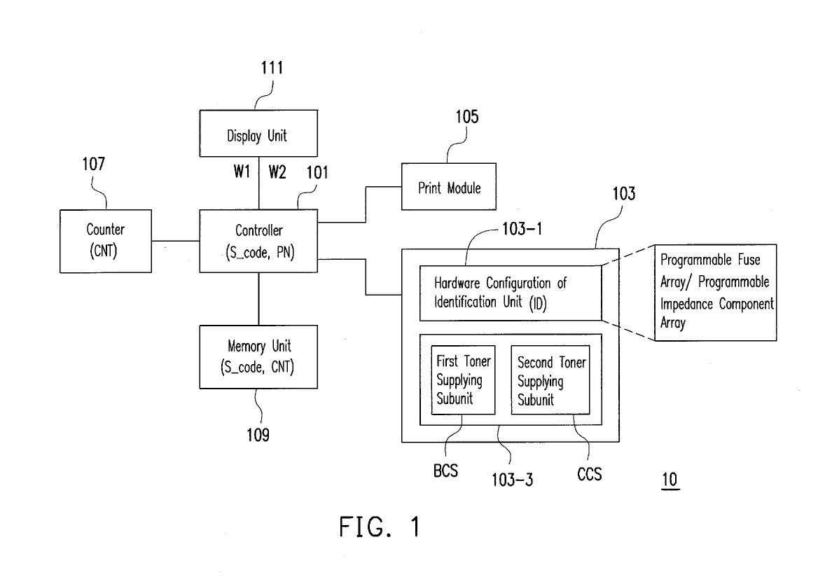

FIG. 1 is a diagram of a printer 10 according to an embodiment of the present disclosure. Referring to FIG. 1, the printer 10 can be of any type, including but not limited to: a laser printer, an inkjet printer, or a dot matrix printer. In this embodiment, the printer 10 may include a controller 101, a toner cartridge 103, a print module 105, a counter 107, a memory unit 109, and a display unit 111.

The controller 101 is served as the operation core of the printer 10. That is, the controller 101 manages and controls the overall operation of the printer 10. Accordingly, the display unit 111 is coupled to and controlled by the controller 101. The display unit 111 is served as a display interface of the printer 10 for displaying operation message/information relating to the printer 10. In this embodiment, the display unit 111 may be, but is not limited to a liquid crystal display module (LCM) or an organic light emitting diode (OLED) display module.

On the other hand, the toner cartridge 103 is coupled to the controller 101. Toner cartridge 103 includes a hardware configuration of identification unit 103-1 and a toner supplying unit 103-3. The hardware configuration of identification unit 103-1 may be, but is not limited to a programmable (and irrecoverable) fuse array or a programmable (and irrecoverable) impedance component array.

Moreover, the hardware configuration of identification unit 103-1 would generate a (unique) ID code representing the toner cartridge 103 in response to a setting code (S_code) determined (randomly, maybe) by the controller 101. In this embodiment, the (unique) ID code representing the toner cartridge 103 may be generated by either directly blowing some portion of the fuse of the programmable (and irrecoverable) fuse array, or directly blowing some portion of the impedance component of the programmable (and irrecoverable) impedance component array. In addition, the setting code (S_code) determined (randomly) by the controller 101 would be updated in response to a new toner cartridge also equipped with the hardware configuration of identification unit 103-1. Accordingly, the ID code representing the toner cartridge 103 would be unique.

The toner supplying unit 103-3 is used to supply black toner and/or color toner in response to a print task executed by the controller 101 under a condition of that the controller 101 determines that the ID code is the same as the setting code (S_code). Accordingly, the print module 105 is coupled to and controlled by the controller 101. The print module 105 is used for outputting a print document related to the print task executed by the controller 101. In this embodiment, the toner supplying unit 103 may include a first toner supplying subunit BCS and a second toner supplying subunit CCS. The first toner supplying subunit BCS is used to supply black toner, and the second toner supplying subunit CCS is used to supply color toner. The color toner includes but is not limited to red, green and blue toner.

However, in situations where the controller 101 determines that the setting code (S_code) is different from the ID code, the controller 101 would stop using the toner cartridge 103 and issue a first warning message W1. An example of the aforementioned situation is when the controller 101 cannot read the ID code of the toner cartridge equipped in the printer 10. The first warning message W1 would be displayed through the display unit 111, and thus remind the user that “the toner cartridge currently equipped in the printer 10 is not a genuine toner cartridge”, and require the user to “replace a new (genuine) toner cartridge also equipped with the hardware configuration of identification unit 103-1.”

Furthermore, the counter 107 is coupled to the controller 101. The counter 107 is used for counting a total number of printing sheets of the printer 10 and providing a counting value CNT accordingly. It should be noted that because the amount of the toner (black, color) filled in the toner supplying unit 103 is limited, a predetermined value PN can be set in advance in the controller 101 to limit the upper limit of the total number of printing sheets of the printer 10, in order to maintain the print quality of the printer 10. Assuming that the predetermined value PN in the controller 101 is set to be two hundred, the upper limit of the total number of printing sheets of the printer 10 would also be two hundred, and so on. It is to be noted that the predetermined value PN is not limited to two hundred. When the controller 101 executes one print task, the counting value CNT provided by the counter 107 would increase by one. In other words, if the controller 101 has already executed fifty print tasks, the counting value CNT provided by the counter 107 would be increased to fifty, and so on.

Besides, the memory unit 109 is coupled to the controller 101. The memory unit 109 is used to store the setting code (S_code) determined (randomly) by the controller 101, and store the counting value CNT provided by the counter 107. In this embodiment, the memory unit 109 may be any kind of non-volatile memory, including but not limited to flash memory, hard-disc drive (HDD), or electrically erasable programmable read only memory (EEPROM).

Because the memory unit 109 would store the counting value CNT provided by the counter 107, the controller 101 would read the counting value CNY stored in the memory unit 109 whenever the printer 10 is activated, to configure the counter 107. Thus, the controller 101 would synchronize the counting value CNT counted by the counter 107 and the counting value CNT stored by the memory unit 109. Accordingly, when the controller 101 determines that the counting value CNT, provided by the counter 107, is larger than the predetermined value PN, the total number of printing sheets of the printer 10 has reached the upper limit. As a result, the controller 101 would stop using the toner cartridge 103 and issue a second warning message W2 through the display unit 111. Consequently, the user would be notified that “the toner cartridge 103 currently equipped in the printer 10 is empty”, and be required to “replace a new (genuine) toner cartridge also equipped with the hardware recognition of identification unit 103-1.”

Based on the above, when the printer 10 is activated, the controller 101 would read the ID code representing the hardware recognition of identification unit 103-1 in the toner cartridge 103. Accordingly, the controller 101 would determine whether the ID code read is the same as a default identification code representing a new toner cartridge. If the controller 101 determines that the ID code read is the same as the default identification code representing a new toner cartridge, the toner cartridge 103 is a new toner cartridge. As a result, the controller 101 would determine (randomly) a setting code (S_code) to be stored in the memory unit 109. The hardware configuration of identification unit 103-1 of the toner cartridge 103 would generate an (unique) ID code representing the toner cartridge 103 in response to the setting code (S_code) determined (randomly) by the controller 101. As a result, the toner cartridge 103 with the ID code (unique) may supply black and/or color toner in response to the print task executed by the controller 101. In other words, the printer 10 is in a normal operation condition.

On the other hand, if the controller 101 determines that the ID code read is not the same as the default identification code representing a new toner cartridge, the toner cartridge 103 is an old toner cartridge. As a result, the controller 101 would determine whether the ID code read is the same as the setting code (S_code) stored in the memory unit 109. If the controller 101 determines that the ID code read and the setting code (S_code) stored in the memory unit 109 are the same, the controller 101 would then determine whether the counting value CNT, provided by the counter 107, is larger than the predetermined value PN.

If the controller 101 determines that the counting value CNT, provided by the counter 107, is not larger than the predetermined value PN, the total number of printing sheets of the printer 10 has not reached the upper limit. As a result, the toner cartridge 103 with the (unique) ID code may supply black and/or color toner in response to the print task executed by the controller 101. In other words, the printer 10 can operate normally. However, if the controller 101 determines that the counting value CNT, provided by the counter 107, is larger than the predetermined value PN, the total number of printing sheets of the printer 10 has reached the upper limit. As a result, the controller 101 would stop using the toner cartridge 103 and issue the second warning message W2 for displaying through the display unit 111. Consequently, the user would be reminded that “the toner cartridge 103 currently equipped in the printer 10 is empty”, and be required to “replace a new (genuine) toner cartridge also equipped with the hardware recognition of identification unit 103-1.”

Furthermore, in situations where the controller 101 determines that the ID code read is different from the setting code (S_code) stored in the memory unit 109, the controller 101 would stop using the toner cartridge 103 and issue the first warning message W1. An example of the aforementioned situation is when the controller 101 cannot read the ID code of the toner cartridge equipped in the printer 10. The first warning message W1 would be displayed through the display unit 111, and thus the user would be reminded that “the toner cartridge currently equipped in the printer 10 is not a genuine toner cartridge”, and required to “replace a new (genuine) toner cartridge also equipped with the hardware configuration of identification unit 103-1.”

As a result, it is assured that not only the internal component of the printer 10 would be protected from being damaged by unidentified and low-priced dummy toner cartridge, but also the print quality and the service lifetime of the printer 10 can be maintained.

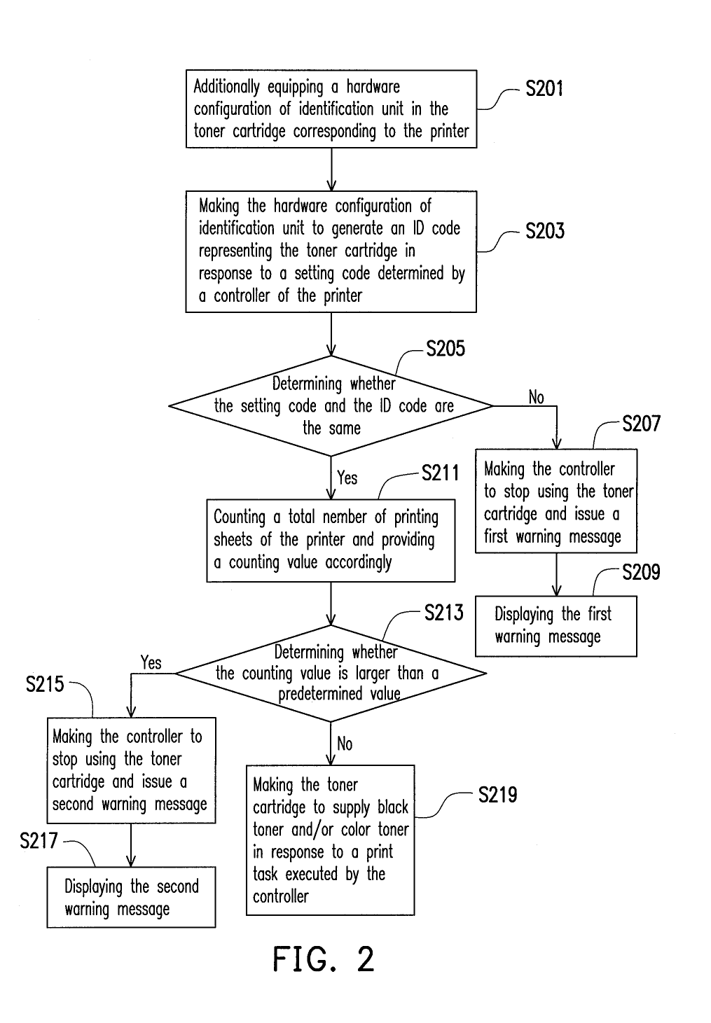

Based on the exemplary embodiments described above, FIG. 2 is a flow chart illustrating a protection management method for a print according to an embodiment of the present disclosure. Referring to FIG. 2, the protection management method of this embodiment includes the following steps.

Additionally equipping a hardware configuration of identification unit in a toner cartridge corresponding to the printer (S201);

Making the equipped hardware configuration of identification unit to generate an ID code representing the toner cartridge in response to a setting code determined (randomly, maybe) by a controller of the printer (S203), wherein the setting code is updated in response to a new toner cartridge also equipped with the hardware configuration of identification unit;

Determining whether the setting code is the same as the ID code (S205); and

When determining that the setting code and the ID code are not the same, making the controller to stop using the toner cartridge and issue a first warning message (S207), and further displaying the first warning message. An example of the first warning message describes “The toner cartridge equipped in the printer is not a genuine toner cartridge. Please replace a new (genuine) toner cartridge also equipped with the hardware configuration identification unit” (S209).

On the other hand, when the setting code is determined to be the same as the ID code, continue to count a total number of printing sheets of the printer and provide a counting value accordingly (S211), and then determine whether the counting value is larger than a predetermined value (S213). When the counting value is determined to be larger than the predetermined value, making the controller stop using the toner cartridge and issue a second warning message (S215), and then display the second warning message (S217). An example of the second warning message describes: “The toner cartridge currently equipped in the printer is empty. Please replace a new (genuine) toner cartridge also equipped with the hardware configuration of identification unit.” On the contrary, when the counting value is determined to be not larger than the predetermined value, making the toner cartridge to supply black toner or color toner in response to the print task executed by the controller.

Based on the above, by additionally disposing a hardware configuration of identification unit (for example, programmable fuse array or programmable impedance component array) in the toner cartridge, the equipped hardware configuration of identification unit would generate a (unique) ID code representing the toner cartridge in response to the setting code (randomly) determined by the controller of the printer. Only when the setting code and the ID code are the same, and when the (black or color) toner filled in the toner cartridge is not empty yet, is the printer allowed to operate normally. Otherwise, the printer is stopped from using the toner cartridge, and the user would be asked to replace a new genuine toner cartridge. As a result, it is assured that not only the internal component of the printer can be protected from being damaged by unidentified and low-priced dummy toner cartridge, but also the print quality and the service lifetime of the printer can be maintained.

What are described above are only embodiments of the disclosure and do not limit the scope of the disclosure. Simple and equivalent variations and modifications according to the claims and specification of the disclosure are still within the scope of the claimed disclosure. In addition, each of the embodiments and claims does not have to achieve all the advantages or characteristics which are disclosed in the disclosure. Moreover, the abstract and title only serve to facilitate search of patent documents and are not intended in any way to limit the scope of the claimed disclosure.

What is claimed is:

1. A toner cartridge for a printer, the toner cartridge comprising:
a hardware configuration of identification unit, for generating an identification (ID) code representing the toner cartridge in response to a setting code determined by a controller of the printer; and
a toner supplying unit, for supplying a black toner and/or a color toner in response to a print task executed by the controller under a condition of that the controller determines that the ID code is the same as the setting code.

2. The toner cartridge according to claim 1, wherein the controller stops using the toner cartridge under a condition of that the controller determines that the setting code is different from the ID code.

3. The toner cartridge according to claim 1, wherein the controller randomly determines the setting code.

4. The toner cartridge according to claim 1, wherein the hardware configuration of identification unit comprises a programmable fuse array or a programmable impedance component array.

5. The toner cartridge according to claim 1, wherein the toner supplying unit comprises:
a first toner supplying subunit, for supplying the black toner; and
a second toner supplying subunit, for supplying the color toner.

6. A printer, comprising:
a controller configured to be served as an operation core of the printer;
a toner cartridge coupled to the controller, the toner cartridge comprising:
a hardware configuration of identification unit, for generating an ID code representing the toner cartridge in response to a setting code determined by the controller; and
a toner supplying unit, for supplying a black toner and/or a color toner in response to a print task executed by the controller under a condition of that the controller determines that the ID code is the same as the setting code; and
a memory unit coupled to the controller, for storing the setting code.

7. The printer according to claim 6, wherein the controller stops using the toner cartridge and issues a first warning message under a condition of that the controller determines that the setting code is different from the ID code.

8. The printer according to claim 7, further comprising:
a display unit coupled to the controller, for displaying the first warning message.

9. The printer according to claim 8, further comprising:
a counter coupled to the controller, for counting a total number of printing sheets of the printer and providing a counting value accordingly.

10. The printer according to claim 9, wherein the memory unit is further for storing the counting value.

11. The printer according to claim 10, wherein the controller stops using the toner cartridge and issues a second warning message under a condition of that the controller determines that the counting value is larger than a predetermined value.

12. The printer according to claim 11, wherein the display unit is further for displaying the second warning message.

13. The printer according to claim 6, wherein the controller randomly determines the setting code.

14. The printer according to claim 13, wherein the setting code is updated in response to a new toner cartridge equipped with the hardware configuration of identification unit.

15. The printer according to claim 6, wherein the hardware configuration of identification unit comprises a programmable fuse array or a programmable impedance component array.

16. The printer according to claim 6, wherein the toner supplying unit comprises:
a first toner supplying subunit, for supplying the black toner; and
a second toner supplying subunit, for supplying the color toner.

17. The printer according to claim 6, further comprising:
a print module coupled to and controlled by the controller, for outputting a print document related to the print task.

18. The printer according to claim 6, wherein the printer comprises a laser printer, an inkjet printer, or a dot matrix printer.

19. A protection management method for a printer, comprising:
additionally equipping a hardware configuration of identification unit in a toner cartridge corresponding to the printer;
making the hardware configuration of identification unit to generate an ID code representing the toner cartridge in response to a setting code determined by a controller of the printer;
determining whether the setting code and the ID code are the same; and
making the toner cartridge to supply a black toner and/or a color toner in response to a print task executed by the controller under a condition of that the setting code is determined to be the same as the ID code.

20. The protection management method according to claim 19, further comprising:
making the controller to stop using the toner cartridge and issue a first warning message under a condition of that the setting code is determined to be different from the ID code.

21. The protection management method according to claim 20, further comprising:
displaying the first warning message.

22. The protection management method according to claim 20, wherein after the step of determining whether the setting code and the ID code are the same, the protection management method further comprises:
counting a total number of printing sheets of the printer and providing a counting value accordingly;
determining whether the counting value is larger than a predetermined value; and
making the controller to stop using the toner cartridge and issue a second warning message under a condition of that the counting value is determined to be larger than the predetermined value.

23. The protection management method according to claim 22, further comprising:
making the toner cartridge to supply the black toner and/or the color toner in response to a print task executed by the controller under a condition of that the counting value is determined to be not larger than the predetermined value.

24. The protection management method according to claim 22, further comprising:
displaying the second warning message.

25. The protection management method according to claim 19, wherein the setting code is randomly determined by the controller.

26. The protection management method according to claim 25, wherein the setting code is updated in response to a new toner cartridge equipped with the hardware configuration of identification unit.
